(19) United States
(12) Patent Application Publication
(10) Pub. No.: US 2019/0381424 A1
(43) Pub. Date: Dec. 19, 2019

(54) CONTINUOUS PROCESS AND EQUIPMENT FOR THE PRODUCTION OF OXIDIZING GAS CONTAINING 39% O2 AND 61% N2 BY WEIGHT, WITH N2 HAVING A PURITY LEVEL BETWEEN 95% AND 98%

(71) Applicant: Francisco Jose JOSÉ DUARTE VIEIRA, Belo Horizonte (BR)

(72) Inventor: Francisco Jose JOSÉ DUARTE VIEIRA, Belo Horizonte (BR)

(21) Appl. No.: 16/484,873

(22) PCT Filed: Feb. 10, 2017
(86) PCT No.: PCT/BR2017/050029

§ 371 Date: Aug. 9, 2019

(51) Int. Cl. B01D 19/00; B01D 53/14; C01B 13/02

(52) U.S. Cl. CPC B01D 19/0036; B01D 53/1418; C01B 2210/0025; C01B 13/0285; B01D 2252/103; B01D 53/1425

(57) ABSTRACT

The object of this patent is aimed at the production of OXIDIZING GAS CONTAINING 39% O₂ AND 61% N₂ BY WEIGHT, WITH N₂ HAVING A PURITY LEVEL BETWEEN 95% AND 98%, whereby the water that will be deaerated is previously aerated at temperatures ranging from ambient down to 0° C., under pressures between 20.6 and 31 atm, only enough to dissolve all the volume of O₂ in the air that is compressed upon it, along with the portion of N₂ of the air, whose capture cannot be dissociated from the process. Afterwards, part of the air is recovered at the top of the deaeration tank, in the form of oxidizing gas, containing 39% O₂ and 61% N₂ by weight, with N₂, which was originally part of the compressed air and was not solubilized in the water, being collected at the top of the aeration or gasification tank showing a purity level between 95% and 98%.

2nd—unlike the State of the Art, which mandatorily requires high water temperature, up to its boiling point, the process degasification, object of the present invention, may be conducted by the preferred embodiment of its pieces of equipment simply by reducing degasification pressure in the degasification tank down to a little bit less than the atmospheric pressure to obtain the same oxidizing gas, and, following degasification, the process water keeps about 20 mg of air, per liter of water, dissolved in itself and, therefore, cannot be used as totally deaerated water.

3—degasification may also be carried out by equipment as formed in the first construction variant of the object of this patent by reducing pressure and, at the same time, increasing the temperature, or sending it, in both embodiments, to the equipment, pre-existing in certain industries, which is used to fully deaerate water and, in these cases, produce the oxidizing gas and fully deaerated water.

### APPLICATIONS OF THE PRESENT PATENT

Capture and partially separate gases from the air by compressing them on the water.
Local production of oxidizing gas containing 39% O₂ and 61% N₂ by weight.
Local production of N₂ with a purity level between 95% and 98%.
Production of totally deaerated water.

### STATE OF THE ART

There is no process similar to the object of the present patent available in the scientific literature and in patent applications, nor in the market, that can via the use of water capture all of the O₂ from the processed air and produce oxidizing gases with varied content of O₂ and N₂ with a purity level between 95% and 98%, and, optionally, fully deaerated water.

This report presents, separately, the States of the Art regarding each one of the fields to which the object of the present patent is related, plus some pertinent criticism.

A—O₂ and N₂ production

B—deaerated water production

C—process through which liquid food may be cold-sterilized by insufflating high pressure N₂ followed by decompression.

The first two fields relate to very early processes that are now all in the Public Domain, whose objectives relate to those of the object of the present invention. The last field—cold sterilization of liquids—introduced quite recently and, therefore, not widely known, will be presented in detail later on in this Patent Report. Its process uses in its forms, values, and different objectives, the gasification and degasification of liquids under high pressure variation of process gases, with fixed and pre-determined temperatures, as it will be presented in detail later on in this Patent Report.

State of the Art for the Production of Both Nitrogen and Oxygen

Nearly 100% of O₂ and N₂ are produced simultaneously using the same piece of equipment, in liquid form, through the century-old cryogenic process.

There is only one alternative technology to cryogenics for the production of O₂ and it's applied to local production, using two different pieces of equipment that supply only gaseous O₂—as no N₂ is produced—to hospitals and some industries.

This technology—introduced back in the 1960s—separates O₂ from the air by filtrating the air through artificial or natural membranes such as zeolitic rocks.

These processes are called ‘Pressure Swing Adsorption (PSA)’ and ‘Vacuum Pressure Swing Adsorption (VPSA)’, which are an improvement of the first type of equipment, both using molecular screens for pressing the atmosphere air, without moisture and particulate, between 3 and 6 bar, thereby causing the screens to retain N₂, methane, carbon monoxide, and dioxide, but releasing O₂. Following this part of the operational cycle, the membranes are cleaned up by releasing the retained gases back into the atmosphere, at which point the second half of the cycle, adsorption, is initiated.

The State of the Art for Water Deaeration

This is considered a century-old process for the removal of O₂ from water intended to be used in the food industry or in boilers as a way to avoid the oxidation of food or piping.

Water deaeration is regarded as a simple technique. The water is heated up to its boiling point and then taken to the deaeration tank where it loses its dissolved gases and becomes O₂-free. The two major gases that make up the air, which are extracted by deaeration, are simply released together into the atmosphere as they are not considered valuable by-products from the process, given that the small quantity of such gases dissolved in the water at ambient pressure and temperature—8.9 mg O₂ and 13.8 mg N₂ per liter of water—is regarded as a by-product that has no value both ecologically and economically.

The State of the Art for the Cold-Sterilization of Liquid Food by Insufflating High-Pressure N₂ Followed by Decompression

The process described by Patent PCT/BR2014/000295, “PROCESS AND EQUIPMENT TO INCREASE THE STORAGE TIME OF LIQUID RAW FOOD”, filed with PCT on Aug. 25, 2014 and numbered PCT/BR2014/000295, examined by the “Written Opinion of the International Searching Authority” and published on Mar. 25, 2015 as a total “Novelty”, an “Inventive Step”, and of “Industrial Application” may be regarded as the State of the Art in the new technological area inaugurated by said patent.

This PCT/BR2014/000295 employs pressure differential in the process, but not temperature differential. Furthermore, the gases that are compressed on the liquid are other than the air and are intended for the cold-sterilization of liquid food by the explosion of the cells of contaminating microorganisms, with said liquid food being previously subjected to N₂ insufflation with up to 10% CO₂, under fixed and invariable temperatures along the process, ranging from 6° C. to 50° C., under pressures raging from 25 to 50 MPa, being subsequently directed to a decompression vessel, under as low a pressure as up to 0.2 bar, leading to a suddenly immediate and large expansion of insufflated gases, which characterizes a deadly explosion of the cells of contaminating microorganisms.

Comments on the State of the Art

The process hereby disclosed is totally different from the description provided by current processes and, particularly, by the process described in Patent PCT/BR2014/000295, given that:

A—in the process, object of the present patent application, the water is gasified with atmospheric air, with maximum economic gasification pressure at 3.1 MPa (±5%) provided the temperature is at 25° C. During the process phases, the temperature of fluids (water and gas) may vary from 0° C. to ambient temperature in the water gasification phase, and gasification may be carried out under ambient temperature up to 85° C.

B—in the process, object of the present patent application, the water may be only the process fluid or else the product, such as the gases of the air extracted from the atmosphere, separated and used, while in PCT/BR2014/000295 patent, the fluids used in the process are the liquid food, N₂ and CO₂, and the temperatures under which the process is conducted are invariable along the process, ranging from 6° C. to 50° C., while pressures range from 25 MPa to 50 MPa, and the only products are the liquid food.

C—as a result of the aforementioned differences relative to the temperatures and pressures of both processes and due to the required embodiment of the pieces of equipment for the intended purpose of each one of these two patents, it's obvious that the pieces of equipment described herein and those described in Patent PCT/BR2014/000295 cannot be used interchangeably, that is, one cannot carry out the same tasks of the other as the high process pressures in the aforementioned PCT, ranging from 25 MPa to 50 MPa, would solubilize all the air volume being compressed on the water, thereby destroying the interface between these two fluids, and creating a single liquid phase in such an extremely critical situation that upon being undone during the deaeration process, it would rebuild the air as it is found in nature and would not be capable of breaking down the air into its main components, nor generate the products object of the present patent.

D—Both the process and the pieces of equipment object of the present patent are not reciprocally capable of sterilizing liquid food, given that the low pressure in their process—maximum 31 atm. or 3.1 (±5%) MPa—is not capable enough to insufflate gases in the necessary amount and at the required pressure to carry out the sterilization through explosion of the microorganisms, as is the case of Patent PCT/BR2014/000295, which requires a pressure between 25 MPa and 50 MPa.

Advancements of the Present Invention in Relation to the State of the Art

The fundamental differences between the present Patent and the State of the Art are as follows:

1^{st}—according to the present patent, the water that will be deaerated is previously aerated at a given pressure only enough to dissolve all the volume of O₂ in the air that is compressed upon it, along with the portion of N₂ of the air, whose capture cannot be dissociated from the process. Afterwards, part of the air, under an opposite temperature at which the process is carried out, is recovered at the top of the deaeration tank, in the form of oxidizing gas, containing 39% O₂ and 61% N₂ by weight, with N₂, which was originally part of the compressed air and was not solubilized in the water, being collected at the top of the aeration or gasification tank showing a purity level between 95% and 98%.

2^{nd}—unlike the State of the Art, which mandatorily requires high water temperature, up to its boiling point, the process degasification, object of the present invention, may be conducted by the preferred embodiment of its pieces of equipment simply by reducing degasification pressure in the degasification tank down to a little bit less than the atmospheric pressure to obtain the same oxidizing gas, and, following degasification, the process water keeps about 20 mg of air, per liter of water, dissolved in itself and, therefore, cannot be used as totally deaerated water.

3—degasification may also be carried out by equipment as formed in the first construction variant of the object of this patent by reducing pressure and, at the same time, increasing the temperature, or sending it to equipment that is found in certain industries, which is used to fully deaerate water and, in these cases, produce the oxidizing gas and fully deaerated water.

The preferred embodiment of the object of this patent, for the recirculating process water at ambient temperature, carries out the local production of oxidizing gas with 39% O₂ and 61% N₂ by weight and N₂ at levels between 95% and 98% with a single processing and the local production of oxidizing and industrial gases with higher O₂ content 39% by weight, through reprocessing the gases obtained in previous processing.

The construction variant of the object of this patent carries out the gasification of air at 0° C., full deaeration of water at 85° C., and produces the same gases as the preferred embodiment.

Both the preferred embodiment and the construction variant that carry out the process object of this patent can be coupled by the bases of their gasification tanks to the full water deaeration equipment used in certain industries for obtaining the oxidizing gas and fully deaerated, with N₂ continuing to be produced in the tops of the gasification tanks.

Uses for the oxidizing gas produced by the object of this patent include:

A—its being added to the combustion air of metallurgical, ceramic and glass furnaces, and internal combustion engines industries to protect the environment because it:

I—reduces excess air for combustion and, consequently, saves fuel,

II—reduces NOx, CO, and CO₂ levels and particulates in waste gases from gas ovens, furnaces, or internal combustion engines,

III—increases the temperature of the flames, allowing biomass to be used in thermal processes and the use of fuels, such as natural gas, which burn with low temperature flames when the combustion air is not enriched by O₂.

B—For every 1% increase by weight of O₂ to the combustion air can result in a temperature rise of 35° C. in the natural gas flame.

C—One liter of oxidizing gas with 39% O₂ by weight can be mixed to 14.7 liters of atmospheric air to increase its O₂ content by 1% or mixed to 4.23 liters of atmospheric air to increase its O₂ content by 3%.

D—Can be used as a local source of O₂ for bleaching pulp and tile and for sewage treatment, thus preserving the decomposing aerobic flora to restore wastewater to the authorization standard for release back into natural water resources.

The embodiment of the process object of this patent just for oxidizing gas production for thermal effects, bleaching materials, and sewage treatment, if carried out using proportions of air on water greater than 1 liter of air per liter of water and at ambient temperatures, involves very low costs because it can use lower gasification pressures. In these cases, the N₂ produced has a lower degree of purity, but keeps the composition of the oxidizing gas at 39% O₂ by weight, being produced in smaller quantities.

The possibility of the process object of this patent being carried out at various temperatures and environmental pressures, by suitable equipment, as well as partial coupling of the equipment that embody the process to equipment designed to deaerate pre-existing water allows for optimization of economic factors, such as initial investments, operating costs, and production levels, as will be described in detail in this patent report.

Calculations and numerical values presented in this report have a degree of significance of ±5% due to the variation in experimental values, rounding off the calculations, deviations from the ideal gas, and variation of the composition and air density owing to the humidity, pressure and atmospheric temperature, and the presence of other gases in the air and refer to the proportion of one liter of air per liter of water, although the process may occur at various temperatures and proportions of these two fluids, generating easily determinable results, with 25° C. being regarded as the ambient temperature.

Scientific Basis of the Object of this Patent

The scientific basis underlying the operation of the “CONTINUOUS PROCESS AND EQUIPMENT FOR THE PRODUCTION OF OXIDIZING GAS CONTAINING 39% O₂ AND 61% N₂ BY WEIGHT, AND DEAERATED WATER” is that the property of the water that acts as an O₂ concentrator when it dissolves the air gas, because the solubility index of O₂ is greater than 1.7 times than that of N₂ and all stages of the process take place according to the General Theory of Gases, Henry's Laws relating to the solubility of gases in liquids—temperature effects, total pressure and partial pressure of gas—and tables of solubility of gas in water.

For all practical purposes, O₂ and N₂ in the air, respectively accounts for 21% and 79% by volume and 23.3% and 76.7% by weight; however, due to the superiority of the solubility index of O₂ in relation to that of N₂, O₂ and N₂ respectively account for 39.2% and 60.8% by weight and 35.7% and 64.3% by volume on the surface layer of a freshwater lake.

At a temperature of 25° C. and 1 atmosphere pressure, one liter of water, in sufficient contact with 1 liter of air dissolves 22.7 milligrams thereof; from the total deaeration of the water thus aerated, 22.7 mg of a gas composed of 8.9 mg of O₂ and 13.8 mg N₂ or 39% O₂ and 61% N₂ by weight are obtained.

Air density is 1.180 mg per liter at one atmosphere pressure at 25° C. and is composed of 275 mg of O₂ and 905 mg N₂; 22.7 mg of air dissolved in water under these temperature and pressure conditions result in a solubility of air in water, in air milligrams per kilogram of water, of only 1.9% gas by weight.

Given that the amount of a gas soluble in a liquid is also directly proportional to the gas pressure exerted on it, a pressure of (1 atm/0.019)=52.7 atmospheres, 1 liter of water completely solubilizes 1 liter of air, but when removed from said pressure, the dissolved air returns to a gaseous state and returns to its form as it is in nature.

Therefore, at a temperature of 25° C., the required pressure to solubilize all the O₂ in the air in order to produce an oxidizing gas, along with N₂, which is indissociable from the process, has to be lower than (1180/22.7) or 52 atmospheres. In fact, at a temperature of 25° C., to capture all the O₂ in one liter of air by solubilizing it within one liter of water, with a minimum quantity of N₂ solubilized in said water, the pressure, not higher than the required one, and that, therefore, is capable of dissolving, concomitantly, the lower quantity of N₂, is (275 mg O₂/8.9 mg O₂/atm)=31 atm.

The threshold pressure for carrying out the process at the most economical way, object of this patent, is always the one just enough to remove from the air all the O₂ contained therein, by solubilizing the air in the water containing the least amount of N₂ at that temperature.

Likewise, as for the operating temperature limits of this process, object of this patent, the minimum temperature is that at which water is still in liquid form—0° C.—and the highest, theoretical temperature for carrying out the process is one in which air solubility in water is still greater than zero, wherein the degasification step of this process can be achieved more economically if carried out at 85° C., with the internal pressure of the degasification tank at 0.5 atmospheres for the oxidizing gas, N₂, and fully deaerated water to be obtained.

The solubility of a gas in water increases with decreasing temperature, in a specific, nonlinear curve; at a temperature of 0° C., at a pressure of 1 atmosphere, in liquid water, 37.2 mg of air per liter of water are dissolved—consisting of 14.6 mg O₂ and 22.6 mg N₂—i.e., the amount of air dissolved in water at a temperature of 0° C. is (37.2/22.7)=1.64 or 64% greater than at 25° C.

To capture all the O₂ from the air at a temperature of 1° C., the operating pressure is less than the required pressure at ambient temperature, which results in economic and environmental gains. The density of one liter of air at 0° C. is 1.293 mg—consisting of 300 mg O₂ and 993 mg N₂. That being the case, (300 mg O₂×atm/14.6 mg O₂)=20.6 atm is enough to capture all of the O₂.

The object of this patent makes no claims regarded the deaeration of water in the conditions of the State of the Art, and the process only refers to water deaeration of previously aerated water under pressure, with the essence of the known State of the Art being only the deaeration of the water by thermal means as if it was exposed to air in nature, without aeration under pressure.

This process allows the recovery of gases dissolved in water under pressure only by decreasing the pressure to degasify the water with the aim to produce oxidizing gas, and the process at a pressure of 31 atmospheres and temperature of 25° C., produces a ratio of 583 ml per 1,000 ml of air treated with the same volume of water and also produces 417 ml of N₂ with a purity between 95% and 98%.

Process Description, Figures and Functionality of the Preferred Embodiment and the Construction Variant of the Pieces of Equipment that Carry Out the “CONTINUOUS PROCESS AND EQUIPMENT FOR THE PRODUCTION OF OXIDIZING GAS CONTAINING 39% O₂ AND 61% N₂ BY WEIGHT, WITH N₂ HAVING A PURITY LEVEL BETWEEN 95% AND 98%”, Object of the Present Invention.

The process, object of the present invention, “CONTINUOUS PROCESS AND EQUIPMENT FOR THE PRODUCTION OF OXIDIZING GAS CONTAINING 39% O₂ AND 61% N₂ BY WEIGHT, WITH N₂ HAVING A PURITY LEVEL BETWEEN 95% AND 98%”, is carried out by their pieces of equipment in a three-step sequence that produces an oxidizing gas of 39% O₂ and 61% N₂ by weight in a single process and then reprocessed by the same equipment, using the same three steps for obtaining oxidizing gases with levels greater than 39%, the production of N₂ with a purity between 95% and 98%, and partial or complete deaeration of water, which can be recirculated as process fluid in the event the process be carried out completely in varying environmental temperatures to produce only the oxidizing gas and N₂ and, if the third step of the process is carried out at 85° C. and a pressure of 0.5 atmospheres, deaerated water is obtained, of which only the part of its equipment that is responsible for the capture and gasification of the water and removal of the N₂ may be coupled to pre-existing equipment for total water deaeration to obtain these same results with smaller investments, as follows:

1^{st} step—gasify the water by atmospheric air compression on it at temperatures that may range from slightly above its solidification temperature and possibly lower than its boiling point, in variable pressures and just enough to solubilize in water all the O₂ in the air at a temperature at which the process is carried out, between 20.6 (±5%) atmospheres at 0° C. and 31 (+/−5%) atmosphere at 25° C., as the proportions of air and water may vary, with the mixture of gasified water and the gas sent at the same gasification temperature and pressure to a gasification tank,

2^{nd} step—maintain the pressure and temperature of the first step inside the gasification tank, while removing from its top the N₂ that was not solubilized in water and separate, by draining the gasified water which accumulates at the bottom of the gasification tank, sending said water to the degasification tank, while still at this pressure and temperature,

3^{rd} step—degasify the gasified water and separated from the gases that were on it in the second step in a degasification tank by decreasing gas pressure on it, and may or may not be an increase of the fluid temperature and then collect the oxidizing gas obtained at the top of the degasification tank, in its own gas holder, containing 39% O₂ and 61% N₂ by weight, and the water collected in the bottom of the degasification tank is recycled as process fluid or, in the event it is fully deaerated, depending on the temperature and pressure at which it was degasified by the equipment itself or external total water deaeration equipment, this water is also a product of the process.

The equipment used in the “CONTINUOUS PROCESS AND EQUIPMENT FOR THE PRODUCTION OF OXIDIZING GAS CONTAINING 39% O₂ AND 61% N₂ BY WEIGHT, WITH N₂ HAVING A PURITY LEVEL BETWEEN 95% AND 98%.”—may carry it out:

A—by the preferred embodiment at ambient temperature in all the three steps described herein, for instance, at a temperature of 25° C. and pressure between 29.45 and 32.55 atmospheres, i.e., at the pressure of 31 atmospheres (±5%) in gasification to achieve a pressure that is just enough so that any O₂ contained in this volume of air will be dissolved in water, with minimum simultaneous dissolution of N₂, with the volumes of air and water varying at any temperature at which the process could be effected and, consequently, the pressures and the processing results varying, so that 1 liter of air per liter of water at 25° C. produces the following results:
704 mg, or 583 ml, of the oxidizing gas, consisting of 276 mg—or 210 ml—of O₂, and 428 mg—or 373 ml—of N₂, and, as such, with 39% O₂ and 61% N₂ by weight and
481 mg, or 417 ml, N₂ with a purity between 95% and 98%,

with the water being only the process fluid, because under such temperature and pressure conditions the water cannot be fully degasified or deaerated, because the water thus processed, at the end of the third step, still contains 8.9 mg O₂ and 13.8 mg N₂, or 22.7 mg dissolved air therein, corresponding to 1.9% air by weight per liter of water, such as occurs naturally in water exposed to air at ambient temperature and pressure;

B—in its first construction variation in higher cost equipment with devices capable of altering the temperature of the fluid between the three processing steps which allow the gasification to be effected at a temperature of 0° C. and at a pressure of between 19.57 and 21.63 atmospheres, i.e. at a pressure of 20.6 atmospheres (±5%), both pressure and temperature being kept equal in the second step—and degasification or deaeration is performed at a temperature of 85° C. and a pressure of 0.5 atmospheres, with which it may be possible to obtain 766 mg—or 635 ml—of the oxidizing gas with 39% O₂, and N₂ and 61% by weight composed of 301 mg—or 229 ml—O₂ and 465 mg—or 406 ml—N₂ containing between 95% and 98%—values already corrected for the volumes at 25° C. with an increase of 9% in its air capture efficiency, which also allows for obtaining fully deaerated water.

Although shown only in the preferred embodiment, the construction variant may also include a gas holder, valves, and by-pass ducts to reprocess the gas obtained, as well as send the gasified water, already separated from the undissolved N₂, along with O₂, for gasification in external deaerators in relation to the object of this patent.

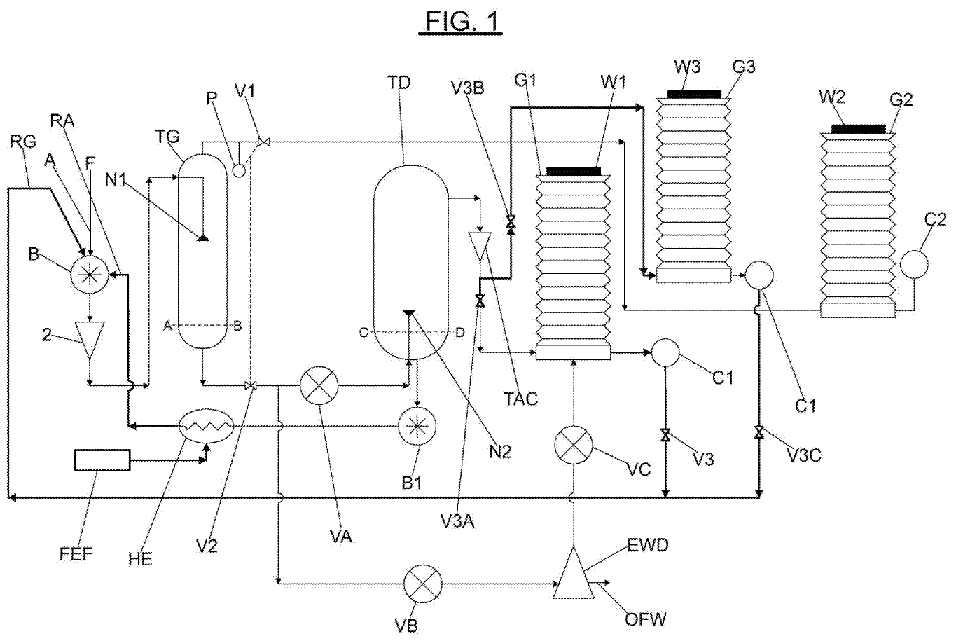

FIG. 1 illustrates and describes the operation of the preferred embodiment of the equipment for the “CONTINUOUS PROCESS AND EQUIPMENT FOR THE PRODUCTION OF OXIDIZING GAS CONTAINING 39% O₂ AND 61% N₂ BY WEIGHT, WITH N₂ HAVING A PURITY LEVEL BETWEEN 95% AND 98%,” (1), object of this patent, highlighting (in thicker lines) the circuit and equipment to optionally reprocess oxidizing gases, in which we see the intakes for atmospheric air (A) and oxidizing gases in reprocessing (RG), the water coming from the water recycling, (RA) and new water supplies (F), the rotary pump (B) that mixes, emulsifies, and solubilizes such gases at a pressure of 10 atm and injects into a non-oil-cooled compressor (2); the fluid formed by mixing a still partially aerated water, and air or reprocessing gases (RG) exit the compressor (2) at a pressure of 31 atm and are injected into the gasification tank (TG) through the nebulizer (N1); the water is maintained in the presence of compressed air—or gases in reprocessing—at the base of the inside of the gasification tank (TG) and always at the level indicated by the dotted line (AB); once the process pressure has reached 31 (±5%) atm, the pressured gasified water exits the base of the gasification tank (TG) through the valve (V2) controlled by a pressure switch (P)—opening valve (VA) and closing valve (VB)—is injected through the nebulizer (N2) into the degasification tank (TD), where only by means of a drop in pressure, gas solubility is unmade; FIG. 1 also shows that the water degasified by the degasification tank (TD), which accumulates at its base, up to the minimum level, as indicated by the dotted line (CD), is suctioned out by the pump (B1) and goes to the process's water recycling (RA); the gas with 39% O₂ by weight, which accumulates at the top of the degasification tank (TD) and is suctioned out by the vacuum and compression turbine (TAC), which maintains the inside of the degasification tank (TD) at a pressure just a bit lower than atmospheric air and is stored in an isobaric gas holder (G1), which is flexible and expandable, and is equipped with a weight (W1) at the top, which maintains a constant pressure for supplying oxidizing gas to the consumer (C1); the N₂ that is not solubilized in the process water will accumulate at the top of the gasification tank (TG) and exits through the valve (V1) operated by the pressure switch (P), which releases the gas out when the pressure reaches 31 atm and is collected in the isobaric gas holder (G2), equipped with a weight (W2) at its top, for supplying the consumer with N₂ under constant pressure (C2); the thick lines show the operation, circuit, and equipment used for the concentration of oxidizing gases obtained during each processing, carried out once or more than once, to increase their O₂ content, which occurs when the isobaric gas holder (G1) is at full capacity; by closing valve (V3A) and opening valves (V3) and (V3B), the oxidizing gas in reprocessing contained in the isobaric gas holder (G1) with a given O₂ content after one processing, returns to the reprocessing gas intake (RG), is reprocessed, and then stored in an isobaric gas holder (G3); using the circuits and combinations of openings and closings of valves (V3), (V3A), (V3B) and (V3C), and, in an alternate manner, the isobaric gas holders (G1) and (G3), the oxidizing gases may be reprocessed by the same equipment and have their O₂ levels increased with each reprocessing, with the deviation to external total water degasification equipment done by closing valves (VA) and (V3A) and opening valves (VB) and (VC) to remove degasification by the equipment from the circuit and place the external water deaerator (EWD) within the circuit, and the oxidizing gas captured at the top of the external water aerator (EWD) is collected by the isobaric gas holder (G1), and the deaerated water (OFW), which was continuously supplied to the water supply intake (F) leaves the equipment as a product; the heat exchanger (HE) attached to the an external cooling source (FEF) may optionally be put into operation to cool the water that goes to the recycling water intake (RA) to increase the amount O₂ captured by the equipment, which is about 9.5% higher when carried out at 0° C. instead of 25° C.

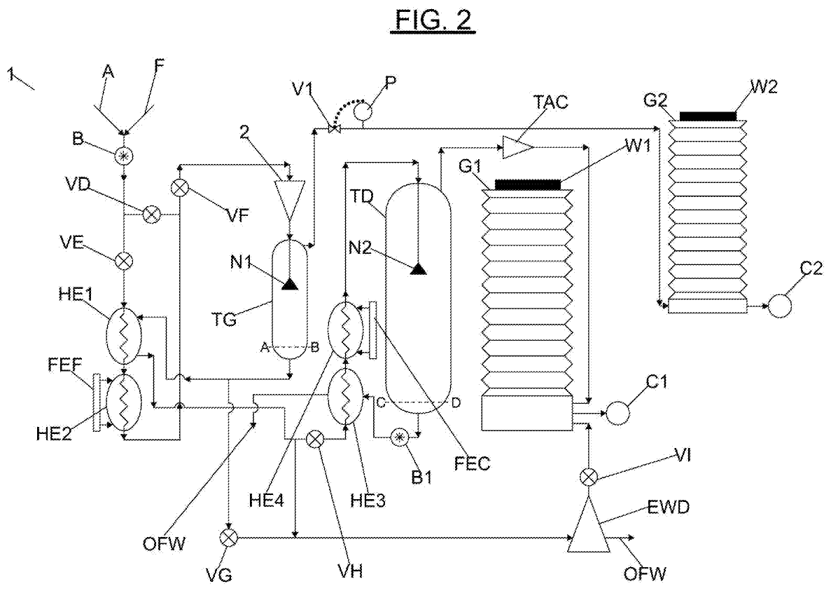

FIG. 2 depicts the equipment and describes the operation of the first construction variation of the “CONTINUOUS PROCESS AND EQUIPMENT FOR THE PRODUCTION OF OXIDIZING GAS CONTAINING 39% O₂ AND 61% N₂ BY WEIGHT, WITH N₂ HAVING A PURITY LEVEL BETWEEN 95% AND 98%,” (1) with devices intended to increase its efficiency in capturing O₂ from the air relative to the preferred embodiment, by changing the temperature of the processing fluid, and also the ability to produce fully deaerated water; pump (B) receives atmospheric air (A) along with water supplied to the process in a constant supply of new water (F); upon exiting pump (B)—valves (VE) and (VF) being opened and valve (VD) being closed—the air and water mixture is cooled to the closest possible temperature to 0° C., first passing through heat exchanger (HE1), where it is cooled by gasified water out from the bottom of the gasification tank (TG) and then passes through heat exchanger (HE2), where it is further cooled by the external cooling source (FEF), and injected into the non-oil lubricated compressor (2), which increases the pressure of the mixture of air and aerated water up to the process pressure, which is 20.6 (±5%) atm at a temperature of 0° C.; the water in the process, gasified and in the presence of undissolved N₂ at a pressure of 20.6 (±5%) atm and a temperature close to 0° C. exits from the compressor (2) and is injected into the aeration tank (TG) through the nebulizer (N1) where it accumulates up to the level shown by the dotted line (AB) on the base of the gasification tank (TG) until it reaches a pressure of 20.6 atm; upon exiting the base of the gasification tank (TG), it exchanges heat in the heat exchanger (HE1) with water and air entering the process, passes through the heat exchanger (HE3) and is heated by the deaerated water coming from the base of the degasification tank (TD) by suction from pump (B1) and leaves the process as deaerated water (OFW); water entering the process, after passing through the heat exchanger (HE3), is heated further by an external heat source (FEC), through the heat exchanger (HE4), and heated to a temperature equal to or greater than the steam pressure consistent with the low pressure prevailing inside the degasification tank (TD)—85° C. at 0.5 atm—and is injected through the nebulizer (N2) into the degasification tank (TD), which completely dissolves the solution of air in water and all of the gases dissolved in water is released and accumulates at the top of the degasification tank (TD), from where it is suctioned out by the suction and compression turbine (TAC) and is injected into the flexible gas holder (G1), which has the weight (W1) on its top to keep the constant pressure steady, from which it goes to the consumer (C1), comprising an oxidizing gas with 39% oxygen by weight in the first processing; the gas that accumulates at the top of the compression tank (TG) from which all its oxygen content is removed when it passes from gas to an aqueous solution, made up of Nitrogen with a purity level between 95% and 98% at a pressure of 20.6 atm, as defined to the process, leaves the gasification tank (TG) top in a continuous movement, being controlled by the valve (V1), which in turn is controlled by the pressure switch (P) and goes to the flexible isobaric gas holder (G2), which is at constant pressure because of the weight (W2) on its upper portion; so that the total degasification of water that is carried out by the resources in this first construction variation—corresponding to the third step of this process—be carried out by an external deaerator (EWD) and the deaerated water (OFW) be supplied to the consumer, valve (VH) is closed and valve (VG) is open, and the external aerator (EWD) provides deaerated water (OFW) to the consumer and through valve (VI), the oxidizing gas goes to the isobaric gas holder (G1) and then to the consumer (C1).

1. “CONTINUOUS PROCESS FOR THE PRODUCTION OF OXIDIZING GAS CONTAINING 39% O2 AND 61% N2 BY WEIGHT, WITH N2 HAVING A PURITY LEVEL BETWEEN 95% AND 98%”, carried out by compressing air over water in a three-step sequence that produces an oxidizing gas of 39% O₂ and 61% N₂ by weight in a single process and if the gas thus produced is reprocessed by the same three stages and the same equipment and a reprocessing gas is obtained with an O₂ content of more than 39% by weight and also N₂ with a purity level of 95% to 98%, where, in the case in which all three steps of this process are carried out at room temperature, partially deaerated water is recycled and the only byproducts in the process are oxidizing gas and N₂ and, when the third step of this process is carried out by raising the temperature to 85° C. and, at the same time, lowering the pressure to 0.5 atmospheres, completely deaerated water can be obtained, in which case the completely deaerated water leaves the Process as a byproduct, being replaced by a new volume of Process water, characterized by:
1^{st} Step. Water gasification—gasify the water by compressing atmospheric air over it at temperatures that may range from slightly above its solidification temperature and possibly lower than its boiling point in variable pressures and just enough to solubilize all the O₂ in the air in Process water at a temperature at which the Process is carried out, between 20.6 (±5%) atmospheres at 0° C. and 31 (±5%) atmospheres at 25° C., as the proportions of air and water may vary with the mixture of gasified water and the gas being sent at the same gasification temperature and pressure to a gasification tank;
2^{nd} step. Nitrogen Removal—carry out the continuous removal of unsolubilized N₂ by keeping the processing fluid at the same pressure and the same temperature as those used in the previous process step at the same time it carries out the continuous removal of carbonated water;
3^{rd} Step. Water degassing—send the carbonated water located at the bottom of the gasification tank, at the Process pressure and temperature, to the degassing tank in which the pressure over it is reduced to atmospheric pressure and the oxidizing gas separates from the water in which it was dissolved under pressure in the previous two Process steps.

2. “CONTINUOUS PROCESS FOR THE PRODUCTION OF OXIDIZING GAS CONTAINING 39% O₂ AND 61% N₂ BY WEIGHT, WITH N₂ HAVING A PURITY LEVEL BETWEEN 95% AND 98%”, in accordance with claim 1, for the production of fully deaerated water, characterized by the fact that the temperature of the gasified water, which has already been separated from the unsolubilized N₂, is raised to 85° C. and its pressure lowered to 0.5 atmospheres in the degassing tank.

3. “CONTINUOUS PROCESS FOR THE PRODUCTION OF OXIDIZING GAS CONTAINING 39% O₂ AND 61% N₂ BY WEIGHT, WITH N₂ HAVING A PURITY LEVEL BETWEEN 95% AND 98%”, to recycle the Process water, in accordance with claim 1, characterized by recycling the partially-degassed water, when the third Process step is carried out at room temperature.

4. “CONTINUOUS PROCESS FOR THE PRODUCTION OF OXIDIZING GAS CONTAINING 39% O₂ AND 61% N₂ BY WEIGHT, WITH N₂ HAVING A PURITY LEVEL BETWEEN 95% AND 98%”, in accordance with claim 1, characterized by reprocessing the oxidizing gas with 39% O₂ and 61% N₂, which is in a suitable gasometer, which is carried out by closing and opening suitable valves to make the processed oxidizing gas return to the Process, with the gas that has been reprocessed being routed to a suitable gasometer.

5. “CONTINUOUS PROCESS FOR THE PRODUCTION OF OXIDIZING GAS CONTAINING 39% O₂ AND 61% N₂ BY WEIGHT, WITH N₂ HAVING A PURITY LEVEL BETWEEN 95% AND 98%”, for recycling the gas that already has an O₂ content greater than 39% by weight and which is stored in a suitable gasometer, in accordance with claim 1, characterized by the oxidizing gas, which has already been reprocessed, being reprocessed once more by closing and opening the appropriate valves, returning it to the Process and, after being reprocessed, is then stored in the appropriate gasometer.

6. “CONTINUOUS PROCESS FOR THE PRODUCTION OF OXIDIZING GAS CONTAINING 39% O₂ AND 61% N₂ BY WEIGHT, WITH N₂ HAVING A PURITY LEVEL BETWEEN 95% AND 98%”, with the gasification and N₂ removal steps being carried out at a temperature as close to 0° C. as possible, in accordance with claim 1, characterized by mixing of the air coming from the atmospheric air supply inlet with the supplied water being cooled in a heat exchanger, which has an external cooling source, and at a temperature close to 0° C., and having its pressure raised to 20.5 atmospheres, followed by a nebulizer that injects them into a gasification tank to separate the N₂ from the carbonated water, which is then routed to the base of an isobaric gasometer;

7. “CONTINUOUS PROCESS FOR THE PRODUCTION OF OXIDIZING GAS CONTAINING 39% O₂ AND 61% N₂ BY WEIGHT, WITH N₂ HAVING A PURITY LEVEL BETWEEN 95% AND 98%”, with the gasification and N₂ removal steps being carried out at the temperature as close to 0° C. as possible, in accordance with claim 1, characterized by the aerated water that has already been separated from the N₂ being heated and routed to the gasification tank;

8. “CONTINUOUS PROCESS FOR THE PRODUCTION OF OXIDIZING GAS CONTAINING 39% O₂ AND 61% N₂ BY WEIGHT, WITH N₂ HAVING A PURITY LEVEL BETWEEN 95% AND 98%” in accordance with claim 1, characterized by the gasified water being heated to 85° C. and injected by a nebulizer into a degassing tank operating at a pressure of 0.5 atmospheres.

9. “EQUIPMENT FOR THE PRODUCTION OF OXIDIZING GAS CONTAINING 39% O2 AND 61% N2 BY WEIGHT, WITH N2 HAVING A PURITY LEVEL BETWEEN 95% AND 98%”, to operate at room temperature by recycling Process water, characterized by an atmospheric air supply inlet (A), water inlet (F), and Process recycled water inlet (RA), along with a oxidizing gas inlet (RG), with said inlets connected to a mixed air rotary pump inlet (B) with injection into the compressor (2), which is connected to the nebulizer (N1) located at the top of the gasification tank (TG); said gasification tank (TG) further comprising a pressure switch (P) on its top and a control valve (V1) connected to the isobaric gasometer inlet (G2).

10. “EQUIPMENT FOR THE PRODUCTION OF OXIDIZING GAS CONTAINING 39% O2 AND 61% N2 BY WEIGHT, WITH N2 HAVING A PURITY LEVEL BETWEEN 95% AND 98%”, in accordance with claim 9, characterized by the gasification tank (TG) having a valve at its base (V2) controlled by the pressure switch (P) and valve (VA); said valves (V2) and (VA) being connected to the degassing tank (TD), which comprises a vacuum and compressor turbine (TAC), said turbine (TAC) consisting of valves (V3A), (V3B), and (V3) that are connected to the base of the isobaric gasometer (G1).
